(19) United States
(12) Patent Application Publication
(10) Pub. No.: US 2004/0002995 A1
(43) Pub. Date: Jan. 1, 2004

(54) Context and time sensitive profile builder

(75) Inventors: Jacquelyn Martino, Cold Spring, NY (US); John Zimmerman, Ossining, NY (US); Guy Roberts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/185,405

(22) Filed: Jun. 28, 2002

(51) Int. Cl. G06F 17/00

(52) U.S. Cl. 707/104.1

(57) ABSTRACT

User ratings within an explicit profile for content attributes are collected in a contextual manner, by queries or other user interactions initiated in conjunction with presentation or execution of a selected content item. Upon detecting null or stale ratings associated with at least one attribute value for a selected content item, the user interaction requesting ratings is initiated during or sequentially following presentation or execution of the selected content item. The profile is thus populated over time, but with the user entering values in context with the content being rated and with the possibility of accommodating changes in the user's preferences over time.

### TECHNICAL FIELD OF THE INVENTION

The present invention is directed, in general, to explicit profiles for generating suggestions or recommendations regarding content and, more specifically, to collecting user rating or preference information regarding content for populating an explicit profile in a context relating to the content.

### BACKGROUND OF THE INVENTION

Systems employed in generating guides, or information regarding available options in connection with a particular activity, may produce suggestions or recommendations for the user. Examples of such systems include on-line shopping or information retrieval systems and systems for delivery of content, particularly entertainment content such as audio or video programs, games and the like. In the case of systems delivering entertainment content, automatic action may be triggered by the generation of a suggestion or recommendation, such as caching, during a period when the entertainment content is not being utilized by the user, at least a portion of available entertainment content for later presentation to the user.

In generating suggestions or recommendations, suitable results are most often obtained by employing, at least in part, an explicit user profile of likes and dislikes. In general, such explicit user profiles are generated by user access and completion of a profiling questionnaire, within which the user rates various meta-data descriptors such as (for video content) genre, actor(s), director, title, etc.

Populating or developing an explicit user profile typically must be initiated by the user, and often requires (or allows) users to independently enter values for meta-data descriptors, such as an actor's name or the title of video content. This forces the user to attempt to remember, at the time of profile creation, all relevant values for meta-data descriptors on which actions employing the profile should be based, which is difficult if not impossible.

On the other hand, displaying a list of all possible meta-data descriptor values to the user, from which selections may be made to populate the user's profile, will generally result in the user having to review a list of unwieldy size, or risk missing suitable descriptors. Particularly for cross-media systems (i.e., video, audio and/or other content), the user might be required to select and/or rate items from a list containing tens of thousands of entries. Either alternative (requiring the user to recall relevant items or presenting the user with a comprehensive list), or even a combination of the two approaches, is unduly demanding on the user and requires more time than a user is likely to be willing to spend on the task, and is therefore unsatisfactory.

In addition to requiring user initiation of the profile development, however, the process is also typically decoupled from the media or actions to which the profile relates—i.e., shopping or viewing video content.

There is, therefore, a need in the art for an improved approach to developing explicit user profiles.

### SUMMARY OF THE INVENTION

To address the above-discussed deficiencies of the prior art, it is a primary object of the present invention to provide, for use in system for reception or execution of user-selected content, a mechanism for collecting user ratings within an explicit profile for content attributes in a contextual manner, by queries or other user interactions initiated in conjunction with presentation or execution of a selected content item. Upon detecting null or stale ratings associated with at least one attribute value for a selected content item, the user interaction requesting ratings is initiated during or sequentially following presentation or execution of the selected content item. The profile is thus populated over time, but with the user entering values in context with the content being rated and with the possibility of accommodating changes in the user's preferences over time.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a system employing context-based, system initiated user interactions to populate an explicit profile according to one embodiment of the present invention;

FIG. 2 depicts a system controller implementing context-based, system initiated user interactions to populate an explicit profile according to one embodiment of the present invention; and

FIG. 3 is a high level flowchart for a process of employing context-based, system initiated user interactions to populate an explicit profile according to one embodiment of the present invention.

### DETAILED DESCRIPTION OF THE INVENTION

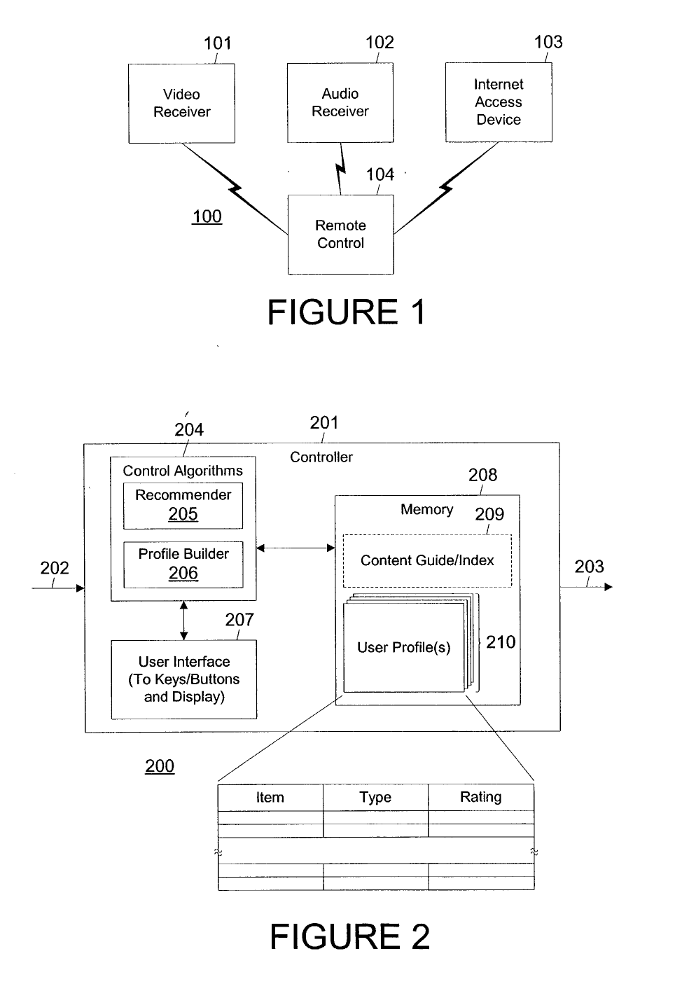

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a system employing context-based, system initiated user interactions to populate an explicit profile according to one embodiment of the present invention. Exemplary system 100 includes: a video receiver and/or playback unit 101 such as a television, a satellite, terrestrial, or cable television broadcast decoder unit, or a digital video recorder; an audio content receiver and/or playback unit 102, such as a terrestrial or satellite radio receiver or a compact disc or digital audio player; and a Internet access device 103 such as a set-top box, personal computer or the like. In the example shown, system 100 further includes a remote control unit 104 capable of interoperating with and controlling the operation of one or more (preferably all) of video receiver 101, audio receiver 102 and Internet access device 103.

Those skilled in the art will recognize that the full construction and operation of a system employing context-based, system initiated user interactions to populate an explicit profile is not depicted or described herein. Instead, for simplicity and clarity, only so much of the construction and operation of the system as is unique to the present invention or necessary for an understanding of the present invention is depicted and described. The remainder of the construction and operation of the system may conform to conventional structures or practices known in the art. Moreover, although a video receiver, an audio receiver, an Internet access device, and a remote control are illustrated in the exemplary embodiment, those skilled in the art will recognize that the functionality described herein may be readily adapted to other types of devices such as, for example, game devices, and thereby employed with other forms of content or in connection with other activities.

FIG. 2 depicts a system controller implementing context-based, system initiated user interactions to populate an explicit profile according to one embodiment of the present invention. The controller hardware and programming 201 for system controller 200 may be implemented in any of video receiver 101, audio receiver 102, Internet access device 103, or remote control 104 depicted in FIG. 1 or in similar devices. Alternatively, controller hardware and programming 201 may be implemented in distributed fashion, with various portions being disposed within two or more of the devices forming the video receiver 101, the audio receiver 102, the Internet access device 103, and the remote control 104.

However implemented, system controller 200 includes at least one input 202 for receiving content and user input control signals, and at least one output 203 for presenting content and user interface displays. System controller 200 receives at least information regarding content available from one or more external sources (not shown) such as a broadcasting facility or a broadcast or Internet content server. In the exemplary embodiment, system controller 200 also selectively receives some of the associated content.

System controller 200 includes control algorithms 204 for controlling operation of one or more of the devices forming the video receiver 101, the audio receiver 102, the Internet access device 103, and the remote control 104. In the exemplary embodiment, the control algorithms 204 include a recommendation utility 205 for generating suggestions based on an explicit user profile and a profile builder utility 206 for collecting rating meta-data as described in further detail below.

Control algorithms 204 are operatively coupled to user interface controls 207 (e.g., buttons or keys, an infrared receiver, and/or a user interface display generator) and to a memory 208 optionally containing a content (e.g., program) guide or index 209 and one or more user profiles 210. As shown, each user profile is, at least in part, an explicit profile in which each specific item associated with an general class or type has an associated rating. At least some of the ratings are supplied by the user intermittently in contextual association with an activity involving rated content as described in further detail below.

Controller 204 employs meta-data associated with content to initiate contextual user interaction to obtain ratings for the content. Based on contextual awareness and knowledge of the meta-data, controller 204 prompts users to respond to questions regarding explicit profiling information in a personalized environment. By way of example, if a user is watching a video program with a predetermined number of meta-data descriptors such as title, genre, actor(s), director(s), etc., controller 204 may initiate a user interface query requesting the user to respond with their level of interest (rating) for each of the descriptors.

The user rating may be set, for example, by the user selecting an arbitrary integer within a predetermined range (e.g., 1 to 100), by the user selecting from among predefined values (e.g., “strongly like” or “moderately dislike”), and/or by the user operating a “slider” user control within the predetermined range.

By coupling the collection of explicit profiling information with the context of the information being ranked or rated, and rather than waiting for the user to access the profiling information input mechanism, the system of the present invention improves explicit profile data by taking the collection initiative based on current usage. Inputs may be requested at the time the user is watching or otherwise using the relevant content, or alternatively may be queued for future access, as long as the user is not required to take the initiative in entering profile information.

In operation, controller 201 receives at least meta-data relating to one or more items of content via input 202, and monitors activity involving such items of content such as user selection of an item for receipt. Upon detection of an item of content being received and/or presented, controller 201 determines whether the meta-data attributes for such item of content have been rated within the explicit profile 210 for the currently active user. If the user profile 210 contains null (or “empty”) data for at least one meta-data attribute of the received or presented item of content, the profile builder 206 initiates a user interaction to receive rating meta-data regarding the content item for the explicit profile 201. The user interaction occurs within a context involving presentation of the item. The term “presentation” is intended herein to include execution of executable content.

In the example of a video reception system, if a program is selected for viewing from currently transmitted programs or from pre-cached programs, the system selectively initiates a user interaction to obtain ratings for the various attributes of the program such as genre, actor(s), etc. The user interaction will be initiated if at least one of the meta-data attributes for the selected program contains null data within the explicit profile. Alternatively, the user interaction may be initiated if the explicit profile contains “stale” data for an attribute—e.g., an attribute value was previously entered by the user on a date preceding the current time by more than a preselected period.

The user interaction may be contemporaneous with presentation of the selected program (e.g., within a small interface region along the bottom edge of the screen) or at a time immediately or shortly following the presentation of the program. If a remote control device having a display (e.g., a liquid crystal display) is employed in connection with presentation of the selected video program on a television, the user interaction may occur on the remote control display rather than (or in addition to) on the television display.

The timing of initiation of the user interaction (i.e., during or following the presentation of the program) may be set by user preference. A user interaction initiated during presentation of the program may include a user control for deferring entry of the user ratings for the attributes until a later time within the presentation or until after completion of the presentation. The user may be allowed to decline to enter ratings for one or all of the attribute values of the program, in which case the corresponding attribute values would be filled with a special value preventing initiation of a subsequent user interaction to obtain ratings for those attributes, and the attribute values would not be employed by the recommendation utility 205 in subsequent evaluations of content.

The present invention supplements other profiling mechanisms, such as user-initiated rating of program attributes and/or user changes to existing ratings for program attributes.

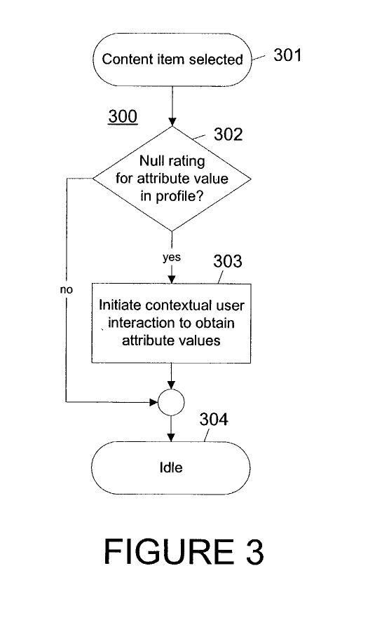

FIG. 3 is a high level flowchart for a process of employing context-based, system initiated user interactions to populate an explicit profile according to one embodiment of the present invention. The process 300 begins with an item of content being selected for viewing, execution of the like (step 301). The attributes and attribute values for the selected item of content are then employed to determine whether the (currently active) user profile contains null, or stale, ratings values associated with the attribute values for the selected content item (step 301).

If a null or stale rating for an attribute value is detected, a contextual user interaction is initiated (step 302). The user interaction may be interrupt viewing or execution of the selected content item, may be concurrently with presentation or execution of that content, or may sequentially follow presentation or execution of the selected content. If the user interaction occurs following the presentation or execution of the selected content item, preferably the interaction occurs as soon after the end of the content item as is viable. After initiation of the user interaction, the process becomes idle (step 304) until another content item is selected by the user.

Based on contextual awareness and knowledge of meta-data associated with content, the present invention prompts users to provide explicit profiling information for a personalized environment in a contextual manner. In the example of video program presentation, a user watching a specific program is prompted with a number of meta-data descriptors and asked to respond with their level of interest regarding each descriptor.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for developing an explicit profile comprising:
an input for receiving at least meta-data relating to one or more items of content;
a recommendation unit for evaluating the one or more items of content based upon the received meta-data and an explicit profile; and
a profile builder initiating user interaction within a context involving presentation of a content item to receive rating data regarding the content item for the explicit profile.

2. The system according to claim 1, wherein the user interaction occurs during presentation of the content item.

3. The system according to claim 1, wherein the user interaction occurs sequentially following presentation of the content item.

4. The system according to claim 1, wherein the user interaction prompts the user to set rating data for the content item.

5. The system according to claim 1, wherein the profile builder initiates the user interaction in response to identifying null or stale rating data for the content item within the explicit profile.

6. A system for developing an explicit profile in a video display system comprising:
a display device for displaying selected items of video content;
a remote control for wirelessly controlling operation of the display device; and
a controller within one or more of the remote control, the display device, and a device interoperable with either the remote control or the display device, the controller comprising:
an input for receiving at least meta-data relating to one or more items of content;
a recommendation unit for evaluating the one or more items of content based upon the received meta-data and an explicit profile; and
a profile builder initiating user interaction within a context involving presentation of a content item to receive rating data regarding the content item for the explicit profile.

7. The system according to claim 6, wherein the user interaction occurs during presentation of the content item.

8. The system according to claim 6, wherein the user interaction occurs sequentially following presentation of the content item.

9. The system according to claim 6, wherein the user interaction prompts the user to set rating data for the content item.

10. The system according to claim 6, wherein the profile builder initiates the user interaction in response to identifying null or stale rating data for the content item within the explicit profile.

11. A method of developing an explicit profile comprising:
receiving at least meta-data relating to one or more items of content;
maintaining an explicit profile containing user ratings for use in evaluating the one or more items of content based upon the received meta-data; and
initiating user interaction within a context involving presentation of a selected content item to receive rating data regarding the selected content item for the explicit profile.

12. The method according to claim 11, wherein the user interaction occurs during presentation of the content item.

13. The method according to claim 11, wherein the user interaction occurs sequentially following presentation of the content item.

14. The method according to claim 11, wherein the user interaction prompts the user to set rating data for the content item.

15. The method according to claim 11, wherein the user interaction is initiated in response to identifying null or stale rating data for the content item within the explicit profile.

16. A signal structure within a system receiving at least meta-data relating to one or more items of content and employing an explicit profile, the signal comprising:
a signal initiating user interaction within a context involving presentation of a content item to receive rating data regarding the content item for the explicit profile.

17. The signal structure according to claim 16, wherein the signal initiating the user interaction is transmitted during presentation of the content item.

18. The signal structure according to claim 16, wherein the signal initiating the user interaction is transmitted sequentially following presentation of the content item.

19. The signal structure according to claim 16, wherein the signal initiating the user interaction prompts the user to set rating data for the content item.

20. The signal structure according to claim 16, wherein the signal initiating the user interaction is transmitted in response to identifying null or stale rating data for the content item within the explicit profile.
